(19) United States
(12) Patent Application Publication
(10) Pub. No.: US 2026/0148276 A1
(43) Pub. Date: May 28, 2026

(54) METHOD OF AND COMPUTER PROGRAM FOR IDENTIFYING GARMENTS FOR A USER

(71) Applicant: BODI ME Ltd, London (GB)

(72) Inventors: Lara MAZZONI, London (GB); Keith TURNER, London (GB)

(73) Assignee: BODI ME Ltd, London (GB)

(21) Appl. No.: 18/960,098

(22) Filed: Nov. 26, 2024

(51) Int. Cl. G06Q 30/0601; G06T 7/60

(52) U.S. Cl. CPC G06Q 30/0627; G06Q 30/0643; G06T 7/60

(57) ABSTRACT

A method of identifying garments for a user. The method includes receiving on a computer device data from a user, the data including height of the user and gender of at least one item of clothing worn by the user. The data further includes at least one of: an identification of at least one predetermined sizing system of the clothing item; a size of clothing of the clothing item; weight of the user; and fit of the clothing item. The data is analyzed to determine body size related data for the user. The same or another computer device receives an image of a garment and establishes locations on the image of a plurality of the features. The distances between the identified features are estimated to determine garment size related data and this is compared to the body size related data to determine how well the garment will fit the user.

### BACKGROUND OF THE INVENTION

The present invention relates to a method of and computer program for identifying garments for a user and relates particularly, but not exclusively, to a method of enabling a user to easily select well-fitting garments when shopping or selecting garments online.

It is becoming increasingly commonplace for garments to be purchased or selected via an online system. Although this is more convenient for many shoppers or users it is difficult for garment retailers and manufacturers as customers are unable to try on a garment before it is purchased. As a result, incorrectly fitting garments must be returned. This both increases vehicle usage and can lead to clothing wastage where garments are not returned but equally not used. As well as business to customer online retail sales, a similar problem exists for businesses with staff uniforms. Employees are often offered the opportunity to select a uniform from an online system and the selected uniform is then delivered to them. It is often the case that multiple items of uniform are ordered at the same time exacerbating the problem of incorrectly fitting items.

A particular problem exists where different garment manufacturers and retailers use different sizing systems. This results in the commonly known problem that purchasing a garment of a particular size from one retailer or manufacturer will not guarantee that a garment offered in the same size from a different retailer or manufacturer will fit. An additional complication is that garment size can be varied with an additional component of garment fit. It is becoming increasingly common for garments to be offered in regular and slim fit as well as petite and tall fits. As is the case with sizes, different manufacturers and retailers have different variations in the way these fits manifest themselves in the garments.

Attempts have been made previously to address these problems and examples of the prior art are disclosed in patent applications published under the following publication numbers EP3996043, U.S. Pat. Nos. 10,332,179, 11,200,610 and WO2020098982.

Preferred embodiments of the present invention seek to overcome or alleviate the above described disadvantages of the prior art.

### SUMMARY OF THE INVENTION

Exemplary embodiments according to the present disclosure are directed to a method of identifying garments for a user, including the steps of receiving on a computer device data from a user, this data including, the height of said user and the gender of at least one item of clothing worn by said user. It also includes at least one of: an identification of at least one predetermined sizing system of the at least one clothing item; a size of clothing of the at least one clothing item; weight of the user; and fit of the clothing item. The data is then analyzed to determine body size related data for the user. Then the same or another computer device receives an image of a garment and establishes locations on the image of a plurality of the features. The distances between a plurality of the identified features are estimated to determine garment size related data for that garment and this is compared to the body size related data to determine how well the garment will fit the user.

According to an aspect of the present invention there is provided a method of identifying garments for a user, comprising the steps: receiving on a computer device data from a user, the data including, height of said user, gender of at least one item of clothing worn by said user, and together with at least one of, identification of at least one predetermined sizing system of said at least one clothing item, size of clothing of said at least one clothing item, weight of said user, and fit of said at least one clothing item, analyzing said data to determine body size related data for said user; receiving on the same or another computer device an image of a garment; establish locations on said image of a plurality of features of said garment; estimating distances between a plurality of said identified features to determine garment size related data for said garment; comparing said garment size related data to said body size related data to determine how well said garment will fit said user; and sending data relating to said matched garments for display on a display device.

By determining body size related data for a user from the limited data input via a series of questions, the advantage is provided that a user is able to, with very little personal intervention, identify the key features of their body size and these can then be matched with garment size related data to identify garments which will have a high likelihood of fitting the user well. This is particularly important as it reduces the likelihood of garments being returned due to not fitting. This has environmental benefits in reducing the journeys undertaken to deliver goods as well as the reducing the likelihood of waste by garments being purchased or selected but then not worn.

When this is combined with using images to identify key features of a garment and determine the garment size related data, it enables single item or small volume production garments to be sold or distributed using online systems. For example, some uniforms are produced in relatively small quantities and therefore using photographs to identify garment size related data and easily matching these two body size related data helps to ensure the good fitting and easy distribution of uniforms. Similarly, where bespoke items are made or altered items are being sold, or the garment dimensions have changed due to washing and/or use, the fitting of these garments to an online purchaser are more likely to be successful enabling the invention to operate in the sale of previously used items or bespoke and customized garments.

In a preferred embodiment the garment size related data is added to a database of garment data for a plurality of garments and said sent data relates to a plurality of garments.

Creating a database of garments with their garments size related data enables a user to select one or more suitable garments from a plurality of potentially fitting garments.

The method may further comprise using an object of a known size to determine scale in said image.

The method also may further comprise using said object of a known size to determine an angle of a camera creating said image relative to a surface on which said garment is placed when photographed.

Using an object of known size, such as a credit card, bank note, coin or a sheet of paper of known size, in order to scale and correctly orientate an image, correcting for camera angle, improves the quality of the garment size related data that is gathered from the images. This in turn enables images to be easily taken without the need for ensuring the image is captured perpendicular to the surface on which the garment is located.

Equally, the method may further comprise using said identified plurality of features of said garment to determine a garment type.

Determining the garment type from the identified features of the garment in the image improves the quality of the input data. In particular, such a system can be used to query a user input which might not match the detected type of garment. This helps to ensure that garments are correctly categorized together and that a limited number of garment type categories are used.

In a preferred embodiment analyzing said data to determine body size related data for said user is performed using a machine learning algorithm.

In another preferred embodiment the data received from the user is obtained by answering questions on a computer device.

In a further preferred embodiment the image of a garment is accompanied by garment data relating to at least one of: manufacturer of said garment; size of said garment; material of said garment; gender of said garment; and fit of said garment, and wherein said garment data is additionally used to determine said garment size related data.

### BRIEF DESCRIPTION OF THE DRAWINGS

Preferred embodiments of the present invention will now be described, by way of example only, and not in any limitative sense with reference to the accompanying drawings in which:

FIG. 1 is a flow chart setting out the steps of an embodiment of the present invention;

FIG. 2 is a schematic representation of a user interface of an embodiment of the present invention;

FIG. 3 is a schematic representation of another user interface of an embodiment of the present invention;

FIG. 4 is a schematic representation of the apparatus used in the implementation of the present invention.

### DETAILED DESCRIPTION OF THE INVENTION

The purpose of the present invention is to enable anyone selecting or purchasing a garment, where they are unable to try on or even handle the garment, can ensure a high likelihood of the garment fitting. This goal is achieved by utilizing two separate but interacting processes which gather body size related data and garment size related data respectively. These data are then matched against each other to find suitable garments for the user purchasing or selecting the garments. Both processes utilize straightforward interactions between the respective users and the computer devices used to gather the data which ensures high uptake of the processes together with a high degree of accuracy in matching users to well-fitting garments. The processes described below are suitable for purchasing garments whether these are through a standard online retailer or through smaller garment sellers who may be selling bespoke, previously used and customized garments. The process is equally suitable for selecting garments for example by uniform distributors.

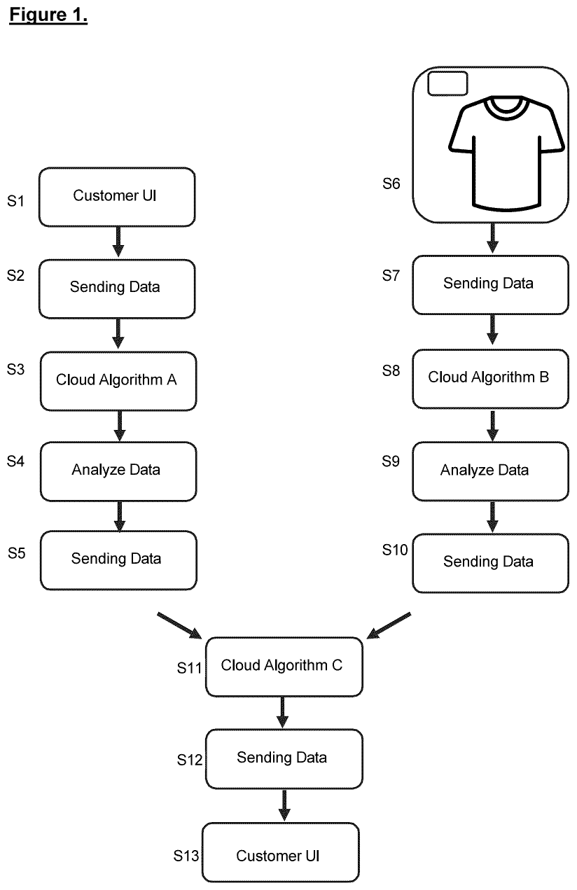

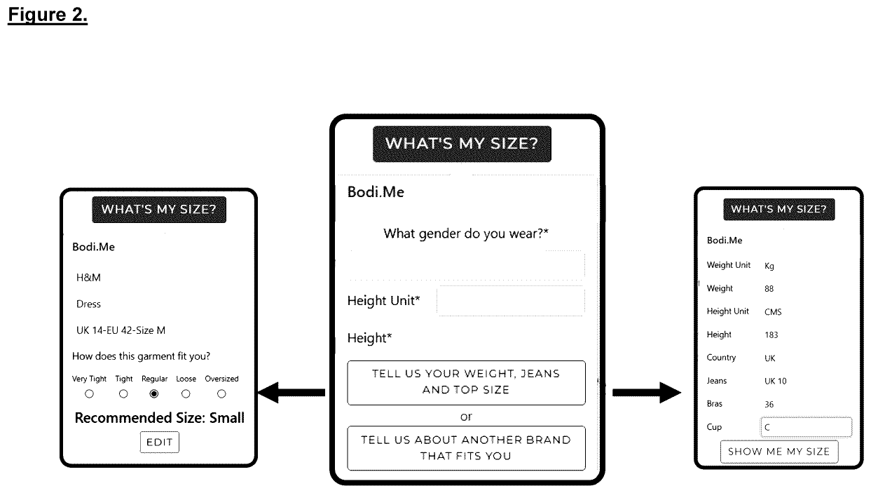

Referring first to FIG. 1, and looking at the gathering of data to determine the body sized related data, a first user enters data into a user interface. The first user is a potential customer wishing to purchase or obtain a clothing garment and this first user enters data in response to questions, on a computer device (step S1). Examples of the questions asked are shown in FIG. 2. These questions include, but are not limited to those in the following list:
a) the height of the first user;
b) the gender of one or more items of clothing worn by the first user;
c) at least one predetermined sizing system of said item or items of clothing from
b);
d) the size of the clothing item or items from b);
e) the weight of the first user;
f) the gender of clothing item or items from b);
g) the fit of clothing item or items from b);
h) the bra size typically worn by the first user.

From this list, it is essential that answers to items a) and b) are provided and that at least one additional answer, from items c) to g) is also provided. As can be seen in FIG. 2, the user interface gives the user options as to the type of information they wish to enter. Some information may be easier for particular users to recall from memory or may be more easily obtained meaning that answering all of the questions might not be possible or not desirable for the user. In b) above the predetermined sizing system is any of the following non-exhaustive list of examples, clothing

manufacturer or retailer sizing system and nationally and internationally recognized and standardized sizing systems.

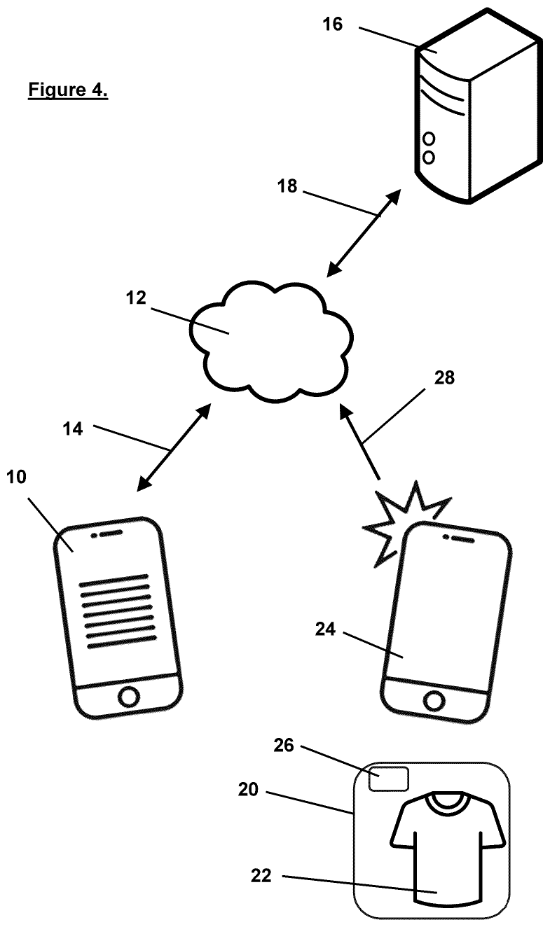

With additional reference to FIG. 4, the questions are asked on a first computer device 10, most typically a mobile computer device such as a mobile telephone connected to the internet 12 via a data connection 14. As the first computer device is a mobile telephone the data

connection 14 is a wireless data connection. Once the user has answered the questions they wish to respond to, the question data collected from the answers to the questions is sent at (step S2) from

the first computer device 10 via the internet 12 to a server 16 via a further data connection 18.

Once the question data is received on the server 16, a processor on the server uses a machine learning algorithm to determine from the data a series of body size related data for the user (steps S3 and S4). The machine learning algorithm uses the data gathered from the user together with data gathered regarding garments and retailers, together with anonymized data of other users, to determine the body size related data for the user. The body size related data can be any suitable measurements of the body. It should be noted that the term body size related data includes but is not limited to body measurement related data as well as other size data. For example, this includes but is not limited to: circumferential measurements around specific locations on the body such as waist, bust, hips and thigh circumference; distances between parts of the body such as arm length and leg length; clothing sizes such as small, medium, large, etc, numerical sizes and the like. The data may be stored in this recognizable form. However, the data may be encoded in any suitable form in order to match with the clothing size related data as set out below. The body size related data is either used immediately or send to data storage for usage later (step S5).

Another aspect of the present invention is the gathering of garment size related data for garments which might be of interest to or might be selected by or might be purchased by the first user if garments can be matched by their garments size related data to the body size related data of the first user. In order to gather the garment size related data, a second user creates an image 20 of a garment 22 using a second computer device 24 which includes an image capture device such as a camera (step S6). Typically, the second computer device 24 is a mobile telephone device. As well as the garment 22, the image 20 includes a reference article 26 of known dimensions. The reference article can be any article of known dimensions but is preferably a standard item that can be selected from a menu on the second computer device 24. Examples of standard items include, but are not limited to, credit cards, sheets of paper of standard known dimensions, bank notes, coins, tape measure or ruler and the like.

The image 20 is transferred from the second computer device 24 via a connection 28 and the Internet 12 to the server 16 (step S7). Once received on the server 16, the image is processed as follows (steps S8 and S9). The standard item 26 is used to scale the image and to correct for the image being taken at a non-perpendicular angle to the surface on which the garment 22 is located when the image is captured. The angle correction utilizes algorithms familiar to person skilled in the art. However, it is not well known to undertake this process using standard household items such as those listed above.

Once the image is corrected for the angle, important features of the garment can be identified. This is achieved using image segmentation which divides the image up into separate part and distinguishes the garment from the background when the image 20 was captured. This can for example be by laying the garment onto a surface with a contrasting colored background but can also be by hanging the garment on a hanger and removing the background or even from extrapolation of information from other photographs using machine learning techniques. The image segmentation creates a silhouette of the garment and identifies the key features either automatically, or when necessary, manually or a combination of automatic and manual recognition. The automatic key feature recognition process utilizes a machine learning algorithm to identify key features such as, in garments such as tops, the arms, body and neck. The dimensions of these features are then calculated with reference to the standard reference article 26.

Once the key features have been identified and their dimensions calculated, the garment size related data can be determined. Like the body size related data this garment size related data includes but is not limited to: circumferential measurements around specific locations on the garment that equate to the body parts such as waist, bust, hips and thigh circumference; distances between parts of the body such as arm length and leg length; clothing sizes such as small, medium, large, etc, numerical sizes and the like. The garment size related data is either used immediately or sent to data storage for usage later (step S10).

With the key features of a garment identified, it is possible to identify the garment type simply from those features. As a result, the garment type can be specified or suggested to the second user which assists in the correct categorization of garments within the groups such as shirts, T-shirts, sweaters, trousers, skirts and the like.

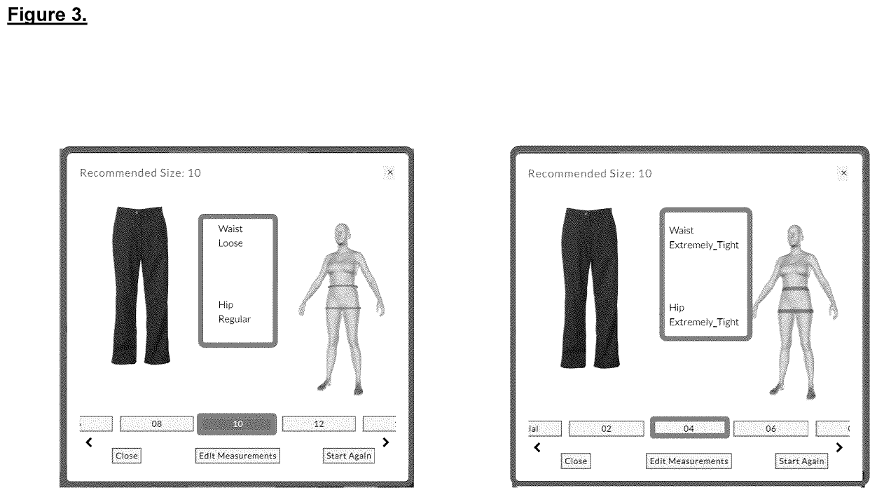

Turning to FIG. 3, once the common size related data and the body size related data have been gathered and stored a comparison can be undertaken to match garments to the first user. Typically, size related data is stored together with further details of a garment and images which can be displayed on a computer device most typically the first computer device 10 of the first user. This allows the first user to select a garment that they wish to purchase or receive. As can be seen in FIG. 3 the likelihood of a garment fitting can be indicated to the user allowing them to only select garments which will fit them suitably. Alternatively, only garments which are likely to be of a suitable fit can be displayed.

It will be appreciated by persons skilled in the art that the above embodiments have been described by way of example only and not in any limitative sense, and that various alterations and modifications are possible without departure from the scope of the protection which is defined by the appended claims. In particular, where various embodiments and aspects of the invention have been described above, features and steps of the apparatus and method are interchangeable between the embodiments and aspects of the invention. For example, where dimensions are indicated in the examples set out above, these are examples of ideal measurements but should not be taken as being indicative of being essential to the performance of the invention. For example, in the embodiment described above the first user and second user are using separate first and second computer devices. In the above embodiment, the first and second users are using different computer device. However, in principle the users could be using the same computer device, although this seems an unlikely scenario. Similarly, in the description above a single server 16 is connected to the internet 12 via a connection 18 and this server 16 receives the data from both the first and second computing devices 10 and 24. However, the data from each of these devices could be held on separate servers which are either directly connected to each other or connected via the internet 12. The term machine learning has been used in the description and it is to be understood that this term includes all forms of artificial intelligence including, but not limited to, neural networks, machine learning and deep learning artificial intelligence algorithms.

What is claimed is:

1. A method of identifying garments for a user, comprising the steps:
receiving on a computer device data from a user, the data including,
height of said user,
gender of at least one item of clothing worn by said user, and together with at least one of,
identification of at least one predetermined sizing system of said at least one clothing item,
size of clothing of said at least one clothing item,
weight of said user, and
fit of said at least one clothing item,
analyzing said data to determine body size related data for said user;
receiving on the same or another computer device an image of a garment;
establishing locations on said image of a plurality of features of said garment;
estimating distances between a plurality of said identified features to determine garment size related data for said garment;
comparing said garment size related data to said body size related data to determine how well said garment will fit said user; and
sending data relating to said matched garments for display on a display device.

2. The method of claim 1, wherein said garment size related data is added to a database of garment data for a plurality of garments and said sent data relates to a plurality of garments.

3. The method of claim 1, further comprising using an object of a known size to determine scale in said image.

4. The method of claim 1, further comprising using said object of a known size to determine an angle of a camera creating said image relative to the object when photographed.

5. The method of claim 1, further comprising using said identified plurality of features of said garment to determine a garment type.

6. The method of claim 1, wherein analyzing said data to determine body size related data for said user is performed using a machine learning algorithm.

7. The method of claim 1, wherein said data received from the user is obtained by answering questions on a computer device.

8. The method of claim 1, wherein said image of a garment is accompanied by garment data relating to at least one of:
manufacturer of said garment;
size of said garment;
gender of said garment; and
fit of said garment, and wherein said garment data is additionally used to determine said garment size related data.

9. A computer program for use in identifying garments for a user, the program comprising:
first computer code for receiving on a computer device data from a user, the data including,
height of said user,
gender of at least one item of clothing worn by said user, and together with at least one of,
identification of at least one predetermined sizing system of said at least one clothing item,
size of clothing of said at least one clothing item,
weight of said user, and
fit of said at least one clothing item,
second computer code for analyzing said data to determine body size related data for said user;
third computer code for receiving on the same or another computer device an image of a garment;
fourth computer code for establishing locations on said image of a plurality of features of said garment;
fifth computer code for estimating distances between a plurality of said identified features to determine garment size related data for said garment;
sixth computer code for comparing said garment size related data to said body size related data to determine how well said garment will fit said user; and
seventh computer code for sending data relating to said matched garments for display on a display device.

10. The computer program of claim 9, wherein said garment size related data is added to a database of garment data for a plurality of garments and said sent data relates to a plurality of garments.

11. The computer program of claim 9, further comprising computer code for using an object of a known size to determine scale in said image.

12. The computer program of claim 9, further comprising computer code for using said object of a known size to determine an angle of a camera creating said image relative to the object when photographed.

13. The computer program of claim 9, further comprising computer code for using said identified plurality of features of said garment to determine a garment type.

14. The computer program of claim 9, wherein analyzing said data to determine body size related data for said user is performed using a machine learning algorithm.

15. The computer program of claim 9, wherein said data received from the user is obtained by answering questions on a computer device.

16. The computer program of claim 9, wherein said image of a garment is accompanied by garment data relating to at least one of:
manufacturer of said garment;
size of said garment;
gender of said garment; and
fit of said garment, and wherein said garment data is additionally used to determine said garment size related data.

17. A system for identifying garments for a user, comprising:
a computer device for receiving data from a user, the data including,
height of said user,
gender of at least one item of clothing worn by said user, and together with at least one of,
identification of at least one predetermined sizing system of said at least one clothing item,
size of clothing of said at least one clothing item,
weight of said user, and
fit of said at least one clothing item,
analyzing on the computer device said data to determine body size related data for said user;
receiving on the same or another computer device an image of a garment;
establishing on that computer device locations on said image of a plurality of features of said garment;
estimating on that computer device distances between a plurality of said identified features to determine garment size related data for said garment;
comparing on that computer device said garment size related data to said body size related data to determine how well said garment will fit said user; and
sending from that computer device data relating to said matched garments for display on a display device.
